(19) United States
(12) Patent Application Publication
(10) Pub. No.: US 2005/0144341 A1
(43) Pub. Date: Jun. 30, 2005

(54) Buffer management via non-data symbol processing for a point to point link

(76) Inventors: Daren J. Schmidt, Chandler, AZ (US); David M. Puffer, Tempe, AZ (US); Sarath Kotamreddy, Chandler, AZ (US); Lyonel Renaud, Gilbert, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/750,013

(22) Filed: Dec. 31, 2003

(51) Int. Cl. G06F 3/00

(52) U.S. Cl. 710/52

(57) ABSTRACT

A number of symbols are received in a first integrated circuit (IC) device, where these symbols have been transmitted by a second IC device and are received over a serial point to point link. These symbols include a non-data sequence that has been inserted into a data sequence by the second device. The symbols are loaded into a buffer. The data sequence and some of the non-data sequence is unloaded from the buffer, according to a changing unload pointer. To prevent overflow of the buffer, and in response to detecting the non-data sequence, the unload pointer is changed by more than one entry so that a non-data symbol of the non-data sequence as loaded in the buffer is skipped while unloading from the buffer. In another embodiment, to prevent underflow of the buffer, the unload pointer is stalled at an entry of the buffer that contains a non-data symbol while unloading. Other embodiments are also described and claimed.

### BACKGROUND

An embodiment of the invention is generally related to serial, point to point interconnect technology suitable for communicatively coupling elements of an electronic system, and particularly to those which have certain aspects that are in accordance with the PCI Express Base Specification 1.0a (Errata dated Oct. 7, 2003) (“PCI Express”). Other embodiments are also described.

An electronic system is composed of several elements that are designed to communicate with one another over an input/output (I/O) interconnect of the system. For instance, a modern computer system may include the following elements: a processor, main memory, and a system interface (also referred to as a system chipset). An element may include one or more integrated circuit (IC) devices. For example, the system chipset may have a memory controller hub (MCH) device that allows the processor to communicate with system memory and a graphics element. In addition, an I/O controller hub (ICH) device may be provided that connects the processor and memory, via the MCH, to other elements of the computer system such as mass storage devices and peripheral devices. In that case, a separate, point to point link such as one defined by PCI Express may be used to allow bi-directional communication between a pair of devices, e.g. the processor and the MCH, the MCH and the graphics element, and the ICH and the mass storage device.

A PCI Express point to point link may have one or more lanes that can operate simultaneously. Each lane has dual, unidirectional paths, which are also simultaneously operable. Each path may have a single set of transmitter and receiver pairs (e.g., a transmitter in a port of Device A, a receiver in a port of Device B). In that case, the transmitter and receiver may drive and sense a transmission medium such as a pair of metal traces in a printed wiring board that may traverse a board-to-board connector. Alternatively, other transmission media may be provided, such as optical fiber.

A point to point link serves to transport various types of information between devices. At a so-called “higher layer”, however, communications between peers in two devices (also referred to as a requester and a completer) may be conducted using transactions. For example, there are memory transactions that transfer data to or from a memory-mapped location. Under PCI Express, there are also message transactions that communicate miscellaneous messages and can be used for functions like interrupt signaling, error signaling, and power management.

There may be three abstract layers that “build” a transaction. The first layer may be the Transaction Layer, which begins the process of turning a request or completion data coming from a device core into a data packet for a transaction. The second architectural build layer is called the Data Link Layer; it ensures that packets going back and forth across a link are received properly (via techniques such as error control coding). The third layer is called the Physical Layer. This layer is responsible for the actual transmitting and receiving of the packet across the link. The Physical Layer in a given device interacts with its Data Link Layer (in the same device) on one side, and with the metal traces, optical fiber, or other transmission medium that is part of the link, on another side. The Physical Layer may contain circuitry for the transmitters and receivers, parallel to serial and serial to parallel converters, frequency and phase control circuits, and impedance matching circuitry. It may also contain circuitry for logic functions needed for its initialization and maintenance. A layered architecture may permit easier upgrades by, for example, allowing reuse of essentially the same Transaction and Data Link Layers, while upgrading the Physical Layer (e.g., increasing transmit and receive clock frequencies).

An example of the behavior of the Physical Layer is now given. Once power up occurs, the Physical Layers on both Device A and Device B are responsible for initializing the link and making it ready for transactions. This initialization process may include determining how many lanes should be used for the link, and at what data rate the link should operate. Sometime after the link is properly initialized, a memory read request is initiated in Device A. Eventually, a packet that includes this read request arrives at Device A's Physical Layer, including headers, error control information, and sequence numbers added by the higher layers. The Physical Layer then takes this packet of data and transforms it into a serial data stream (perhaps after adding framing data to it), and transmits the stream using, for example, an electrical, differential signal having predefined timing rules.

Once the Physical Layer in Device B sees the signal appear at its receiver input, it samples the signal to recover the data stream, and builds the stream back into a data packet (e.g., after removing the framing). The packet is then passed up to the Data Link Layer in Device B, which strips the headers and checks for errors; if there are no errors, the packet is passed up to the Transaction Layer where the memory read request is extracted and then sent to the appropriate logic function to access the locations specified in the request.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 illustrates a pair of integrated circuit devices that are coupled to each other via a serial point to point link.

FIG. 2 shows a block diagram of part of the link interface circuitry used to implement the serial point to point link in an integrated circuit device.

FIGS. 3A and 3B depict a block diagram of circuitry that may be used to implement buffer management in the physical layer of the point to point link.

FIG. 4 shows a timing diagram of how a non-data symbol detection flag may be aligned in the buffer management circuit of FIG. 3.

FIG. 5 is an example timing diagram that illustrates an example of the pointer comparison operation.

FIG. 6 illustrates an example timing diagram for managing the buffer to avoid overflow.

FIG. 7A shows an example timing diagram for managing the buffer to avoid underflow.

FIGS. 7B-7C illustrate a timing diagram of an example start-up condition of the buffer.

FIG. 8 identifies the various elements of a multi-media desktop personal computer some of which are communicationally coupled to each other via PCI Express virtual channels (VCs).

FIG. 9 depicts a block diagram of an enterprise network.

### DETAILED DESCRIPTION

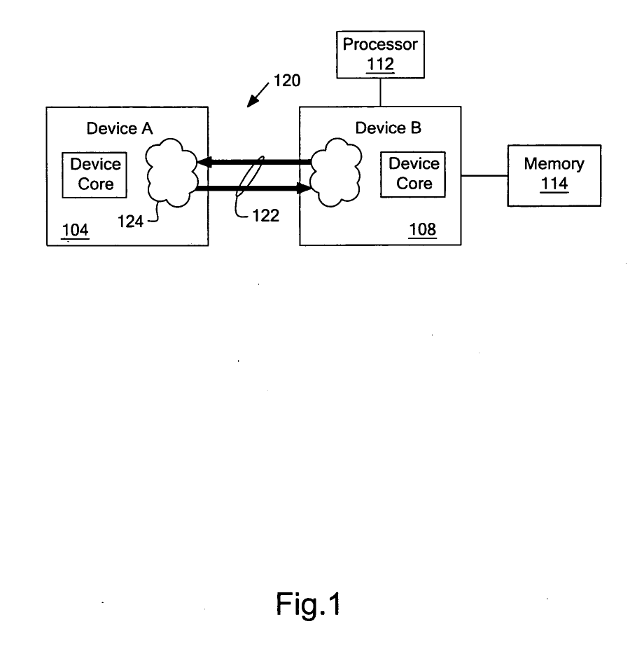

An embodiment of the invention is directed to buffer management by way of non-data symbol processing, for a point to point link. FIG. 1 illustrates a pair of integrated circuit devices that are coupled to each other via a serial point to point link. The IC devices 104 (Device A) and 108 (Device B) may be part of a computer system that contains a processor 112 and main memory 114. In this example, a serial point to point link 120 is used to communicatively couple the core of Device B with that of Device A. The link 120 has dual, unidirectional paths 122, with link interface 124 that serves to interface with the device core of each respective Device A and B.

In this embodiment, Device B is referred to as the root complex of the computer system and provides the processor 112 with I/O access to, for instance, a graphics element in Device A. The root complex may be partitioned into a graphics and memory controller hub (GMCH) and an I/O controller hub (ICH). The ICH would act as a further interface between the GMCH and other I/O devices of the system, including a non-volatile mass storage device, a pointing device such as a track pad or mouse, and a network interface controller (not shown). The point to point link 120 may be duplicated for communicatively coupling the Device B to the processor 112 and the main memory 114. Other platform architectures that feature the point to point link 120 are also possible.

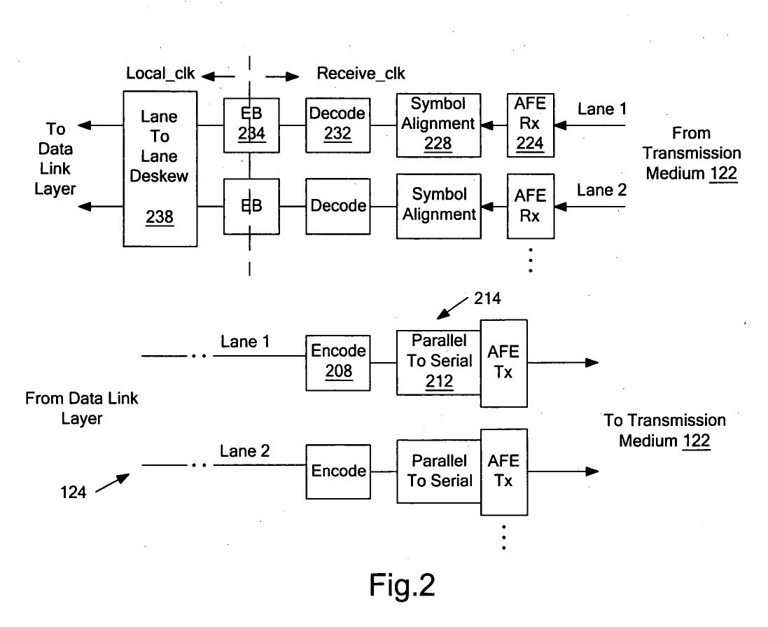

The interface 124 of FIG. 1 may be viewed as implementing the multiple layer architecture (described above in the Background) for a serial point to point link. Some details of the interface 124 are illustrated in FIG. 2. The interface 124 supports independent transmit and receive paths between the transmission medium 122 and the Data Link Layer of its respective device 104, 108. In the transmit path, information in the form of data packets arrive from the Data Link Layer and are divided into symbols that are encoded by an encode block 208. A purpose of the encoding by block 208 is to embed a clock signal so that a separate clock signal need not be transmitted into the transmission medium 122. This encoding may be the well known 8 B-10 B where an eight bit quantity is converted into a 10 bit quantity; other encoding schemes are possible. In some cases, such as where a separate strobe or clock signal is transmitted in the medium 122, there may be no need for such encoding.

Following encoding in block 208, the units of data (referred to here as symbols) are processed by a parallel to serial block 212 of an analog front end (AFE) transmit block 214 to yield a stream of bits. Note that a “bit” as used here may represent more than two different states, e.g. a binary bit, a ternary bit, etc. The term “bit” is used merely here for convenience and is not intended to be limited to a binary bit. The bit stream is then driven into the transmission medium 122. As explained above in the Background, this transmission medium may be a pair of metal traces formed in a printed wiring board. Other forms of the transmission medium 122 may alternatively be used, such as an optical fiber.

The series of blocks 208-214 may serve a single lane of the point to point link 120 (FIG. 1). In general, there may be more than one lane in the point to point link 120, so that a packet received from the Data Link Layer may be “striped” across multiple lanes for transmission.

Turning now to the receive side of the interface 124 shown in FIG. 2, each lane has its associated AFE receive block 224, which serves to receive a stream of information from the transmission medium 122, by for example sampling a signal in the transmission medium 122. The AFE receive block 224 translates between signaling of the transmission medium 122 and signaling of the IC device 104 (e.g., on-chip, complementary metal oxide semiconductor, CMOS, logic signaling). As will be explained below, the stream of information represents sequences of M-bit symbols (where M is an integer greater than 1) that have been transmitted by the Device B over the serial point to point link 120 (see FIG. 1).

The stream of bits provided by the AFE receive block 224 is fed to symbol alignment logic 228 which serves to align or lock onto the symbols that have been received. In other words, and as will be explained below, the symbol alignment logic 228 will demarcate the correct symbol boundaries within the received bit stream, for use by subsequent sections of the Physical Layer in the device 104.

The symbol-aligned bit stream may then be fed to decode block 232 which undoes the encoding performed by encode block 208 (e.g., 10 B-8 B decoding, to yield symbols of information consisting of eight binary bits each).

The decoded symbols are then fed to an elastic buffer, EB 234. The EB 234 serves to compensate for any differences in the tolerance of the rate at which the symbols were transmitted in Device B and a local clock signal (local_clk) of Device A. The local_clk is used to unload symbols from the EB 234, as well as in some cases operate parts of lane to lane deskew circuitry 238 as explained below (in the case where the link 120 is composed of more than one lane). It should be noted that the decode block 232 (if provided) may be placed further downstream, e.g. at the output of the EB 234 or at the output of the deskew circuitry 238.

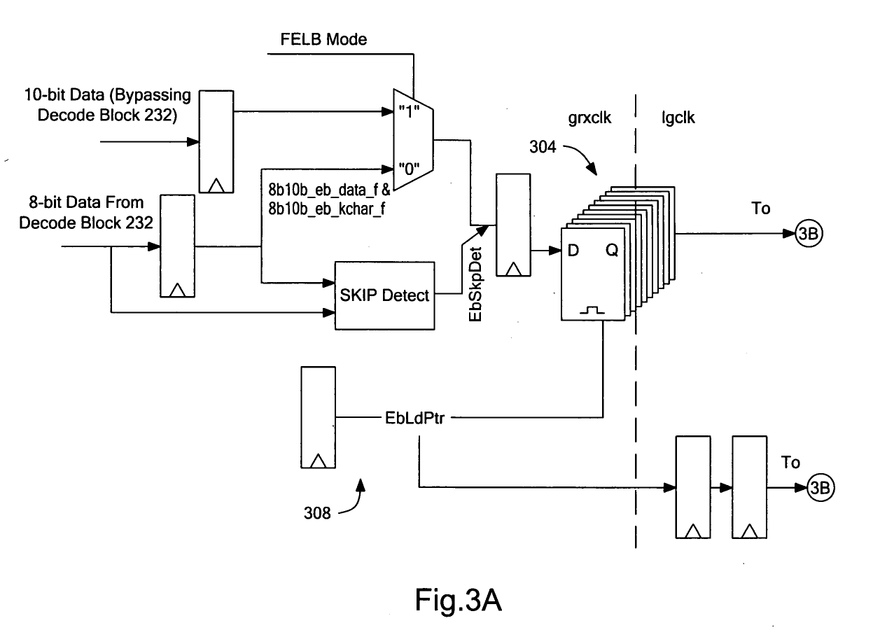

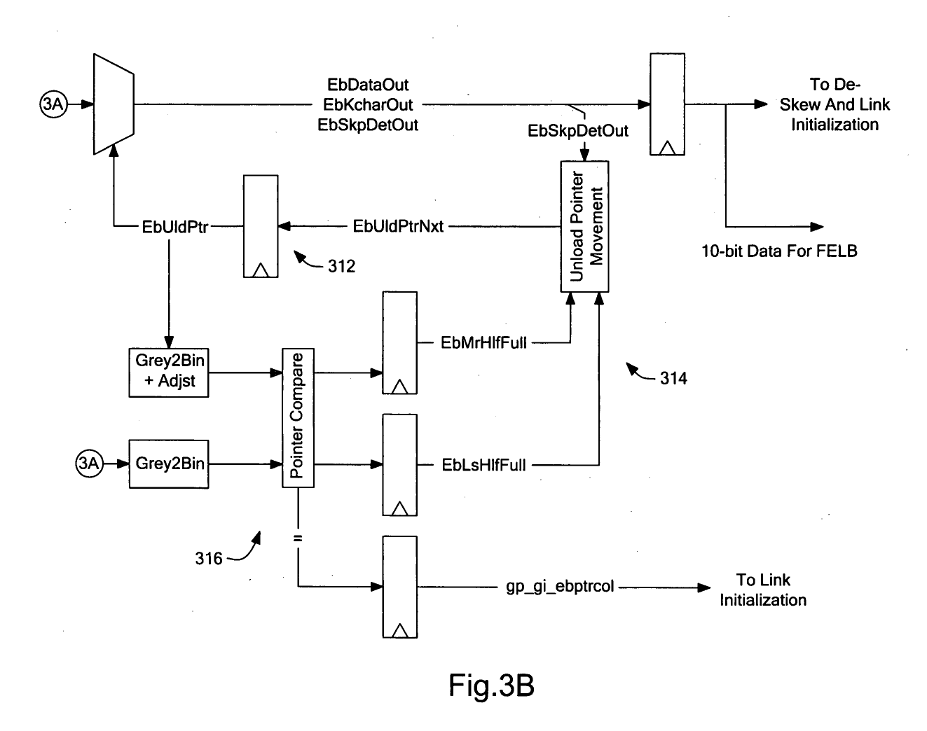

An example block diagram of a part of the EB 234 is depicted in FIGS. 3A and 3B. In this example, the EB 234 has an input (to the left of FIG. 3A) that is to receive 8-bit symbols from the alignment logic 228, via the decode block 232 (see FIG. 2). An alternative here that will be described below is a far end loop back mode (FELB) where the symbols are 10-bits wide because they have bypassed the decode block 232. Other symbol widths are, alternatively, possible.

The symbol may be a “data” symbol that represents some payload that has been sourced by the Data Link Layer, Transaction Layer or some other higher layer such as the device core. Alternatively, a symbol may be a “non-data” symbol, e.g. a special symbol generated by one of the Physical, Data Link, or Transaction Layers, to achieve some type of control over the information that is being transmitted over the serial point to point link. Several examples of such non-data symbols will be given below as PCI Express special symbols.

PCI Express defines a number of special symbols that are added to the packets that are being communicated. For instance, special symbols may be added to mark the start and stop of a packet. This is done to let the receiving device know where one packet starts and where it ends. Different special symbols are added for packets that originate in the Transaction Layer than in the Data Link Layer. In addition, there is a special symbol called “SKP” (skip) which is to be used by the Physical Layer for compensating for small differences in the operating data rates of two communicating ports. There is also a special symbol called “COM” (comma) that is to be used for lane and link initialization by the Physical Layer.

The symbols that arrive at the input of the EB 234 are to be sequentially loaded into a number of entries of a buffer 304 (that may have a first in first out structure, also referred to as a queue) in accordance with a load pointer, EbLdPtr, provided by load pointer logic 308. An unload pointer, EbUldPtr, provided by unload pointer logic 312, is used to sequentially unload the symbols from the buffer 304. As shown in FIG. 3A, there is a vertical dashed line through the buffer 304. This represents the clock crossing that is performed by the EB 234 between the receive clock, grxclk, and a local clock, lgclk. Symbols are loaded in accordance with grxclk, and they are unloaded in accordance with lgclk. Although these two clock domains may be designed to be as close to each other as possible in terms of frequency, each clock domain is allowed some tolerance or a very small variation in frequency, often specified as parts per million (ppm). The grxclk may be derived from a transmit clock of another IC device (that has transmitted the symbols), where this transmit clock may have been either embedded in a stream of information transmitted by the other device, or it may have been provided in a separate clock or strobe signal such as in a source-synchronous scenario. Under PCI Express, the grxclk may have a tolerance of ±300 ppm. The same tolerance may be assigned to the local clock, lgclk, of Device A.

To explain the problem of overflow and underflow of the EB 234 and in particular the buffer 304, assume that at start-up, the load and unload pointers to the buffer 304 are separated by approximately one-half the depth of the buffer. Depending on the actual difference between the frequency of the grxclk and lgclk, these pointers may start to drift apart from each other or may start to drift closer to each other, such that over time the pointers may collide, that is overflow or underflow. An ideal condition for the EB 234 may be that the load and unload pointers are always separated by one-half the depth of the buffer 304. As explained below, this ideal may be sought by adjusting or controlling the unload pointer as a function of a) detecting a special or non-data sequence of symbols, and b) an impending overflow or underflow condition of the buffer, without adjusting the default manner in which the load pointer is updated.

The unload pointer of the EB 234 may be managed (using, e.g. unload pointer logic 312 and pointer control logic 314 in FIG. 3B) to avoid overflow and underflow conditions, using predefined, special or non-data sequences of symbols that have been inserted into a data sequence, by the Device B (see FIG. 1). Briefly, to prevent underflow of the buffer, the unload pointer may be stalled at an entry of the buffer that contains a non-data symbol, in response to detecting the non-data sequence. This is done while unloading the data sequence according to the changing unload pointer. This causes the load pointer to move away from the unload pointer and thereby avoid underflow.

On the other hand, to prevent overflow of the buffer, the unload pointer may be changed by more than one entry so that a non-data symbol of the non-data sequence (as it is presently loaded in the buffer) is skipped, while symbols are being unloaded from the buffer. Once again, this is done in response to detecting the non-data sequence. This causes the unload pointer to move away from the load pointer, again to avoid a collision. Details of an example technique for implementing the overflow and underflow avoidance abilities are given below.

Returning now to FIGS. 3A and 3B, the buffer 304 of the EB 234 may be designed to store, in each entry, not just a symbol (such as an 8-bit or 10-bit character) but also a control bit for the symbol, which indicates whether the symbol is a data symbol or a non-data symbol (8b10b_eb_kchar_f), and a predefined non-data sequence indicator (EbSkpDet). The kchar_f control bit may have been generated by the decode block 232, while EbSkpDet may be generated by the EB 234 logic as shown. The latter indicator is for the particular example of a PCI Express embodiment, where the special, non-data sequence being used is the SKP Ordered-Set. Alternatively, another predefined, non-data sequences may be used. The EbSkpDet non-data sequence indicator may be used by the EB 234 as described below for management of the unload pointer.

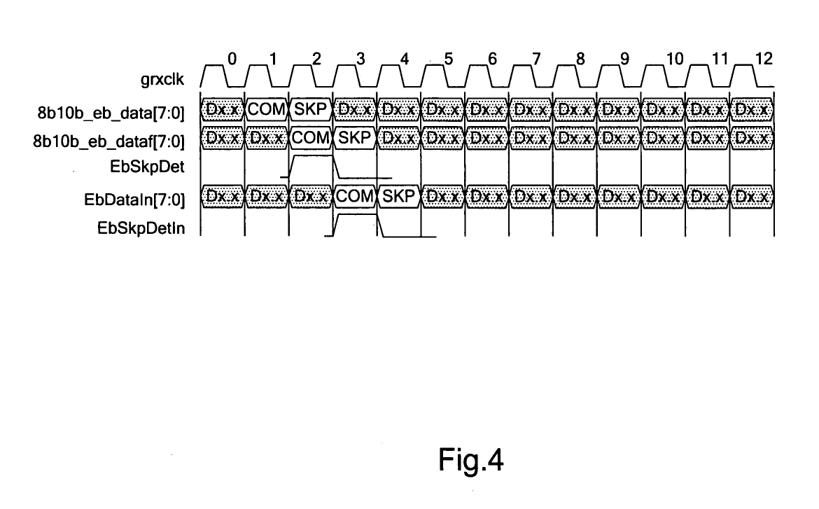

To properly adjust the unload and load pointers of the EB 234, the SKP Ordered-Set detect flag is generated and aligned at the input of the buffer 304, with a received non-data symbol, in this case the PCI Express COM, of the Ordered-Set. The COM symbol precedes one or more SKP symbols in the Ordered-Set. The indicator is passed through the EB 234, so that the correct actions may be taken with respect to the Ordered-Set, in the lgclk domain (to the right of the vertical line shown in FIG. 3A). As illustrated in the timing diagram of FIG. 4, the Ordered-Set indicator may be a signal that is asserted for one cycle of grxclk, when the non-data symbol COM is followed by the non-data symbol SKP. In FIG. 4, the waveform 8b10b_eb_data[7:0]; represents the received symbols (which in this case include the SKP Ordered-Set inserted into a data sequence indicated as the series of Dx.x). Both the received symbols and the Ordered-Set indicator EbSkpDet are flopped before being stored in an entry of the buffer 304. Note how the COM symbol and the assertion of EbSkpDetin occur in the same cycle of grxclk. In other words, the detection flag EbSkpDet is asserted and loaded into the buffer (as EbSkpDetin) along with in this case the 8-bit symbol EbDataIn[7:0].

Referring to FIG. 3B, comparison logic 316 is capable of sampling the position of the unload and load pointers with respect to each other, so that proper adjustment of the pointers may be done when the non-data sequence has been detected. This means, in this embodiment, one of the pointers may need to cross clock domains, to determine the positions of the two pointers within the queue. In this embodiment, the load pointer, in the grxclk domain, will cross over to the lgclk domain. Note that the use of gray scale to represent the pointers may provide for a more accurate and efficient implementation than plain binary.

In the lgclk domain, there are two indicators that are generated to indicate the condition of the buffer 304, that is more than half full or less than half full. As an alternative, other conditions may be defined (such as more full, or less full than a predetermined threshold) that can still allow the EB 234 to avoid overflow and underflow situations. In this example, the more than half full indicator is EbMrHlfFull and signifies that the grxclk domain is “faster” than the lgclk domain. When this indicator is asserted, and when the non-data sequence has been received, a non-data symbol, and in this case the SKP, should be removed from the Ordered-Set to try and bring the buffer back to its ideal, half full condition.

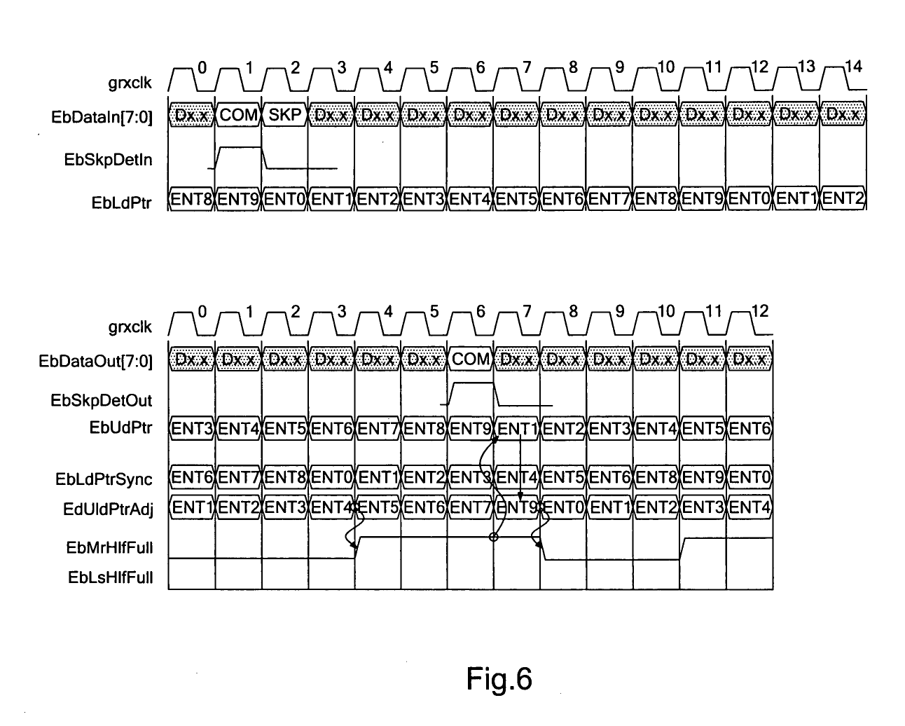

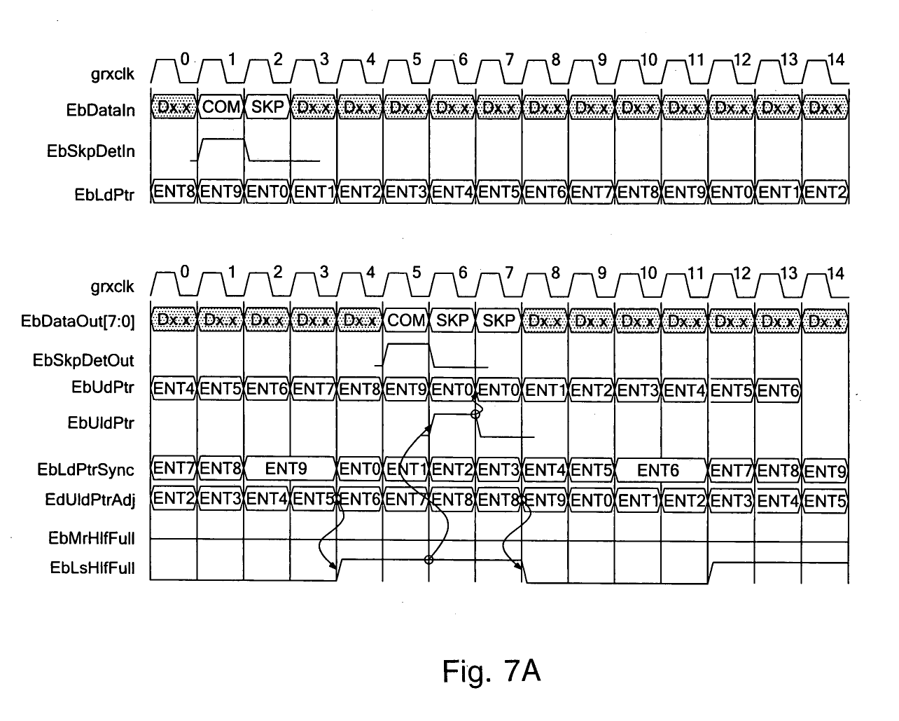

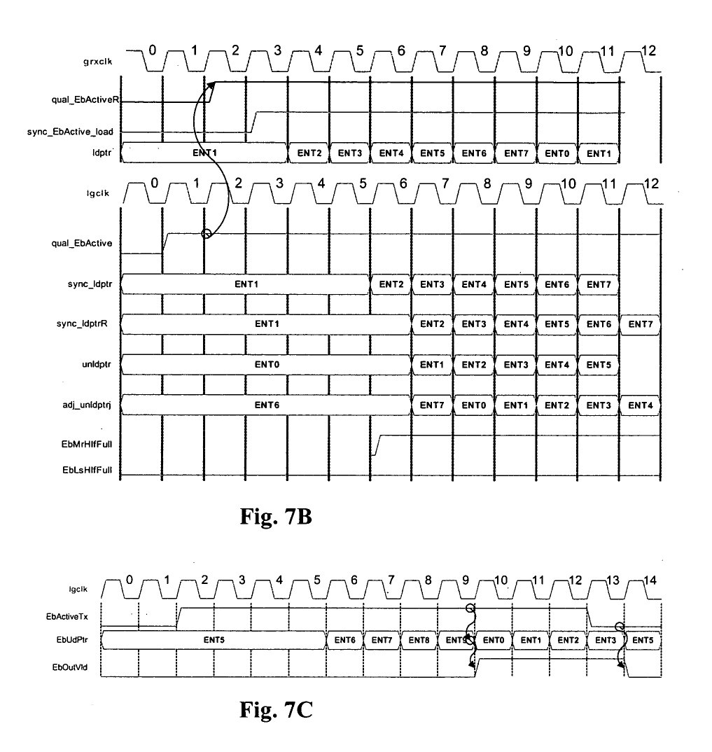

On the other hand, the less than half full indicator (EbLsHlfFull) signifies the reverse, namely that the lgclk domain is faster than the grxclk domain. In that case, when a SKP Ordered-Set has been received, an SKP should be added, to bring the pointers back towards their ideal, that is half full, condition. Of course, when both of these indicators are deasserted, the buffer may be half full such that no action needs to be taken on the load and unload pointers. In an embodiment of the invention, this adding and removal of an instance of the SKP is achieved by the pointer control logic 314 (FIG. 3B) acting upon the unload pointer EbUldPtr (and not the load pointer, EbLdPtr). Its operation may be illustrated by the example timing diagram of FIGS. 6 and 7, that will be described further below.

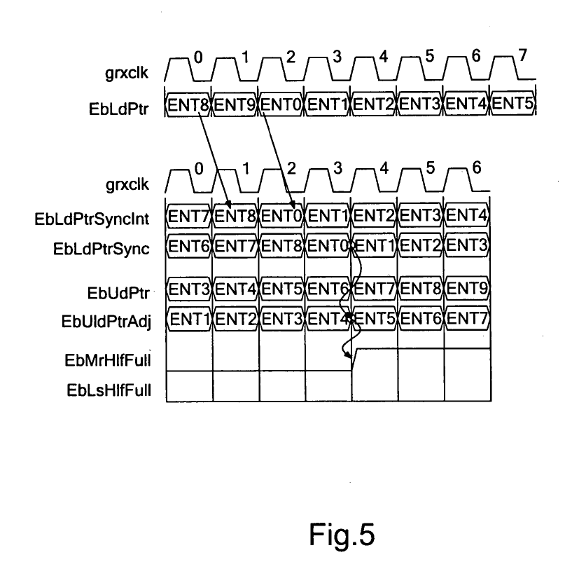

FIG. 5 is an example timing diagram of how the pointers may be compared, in view of them being in different clock domains. FIG. 5 shows the grxclk and lgclk waveforms where in this example grxclk is faster. Here, the load pointer EbLdPtr is crossed to the lgclk domain, with a one to two cycle lag between the actual position of the load pointer and the synchronized position EbLdPtrSync. To compensate for this time delay associated with crossing the load pointer, the value of the unload pointer will also be adjusted, by decrementing the current value by in this example two, to yield EbUldPtrAdj. A comparison will then be made between EbLdPtrSync and EbUldPtrAdj, so that in this case the buffer is more than half full as indicated in cycle 4 of lgclk. Note that in this example, the depth of the buffer 304 is assumed to be ten entries although other depths may also work.

Still referring to the timing diagram of FIG. 5, note that in the first four cycles of lgclk, the synchronized load pointer, EbLdPtrSync, differs from the adjusted unload pointer EbUldPtrAdj by about one-half the depth of the buffer, that is five entries in this case. Accordingly, both EbMrHlfFull and EbLsHlfFull are deasserted. However, in cycle 3, the synchronized load pointer jumps ahead by one entry (from entry 8 to entry 0), and because this difference between the two pointers is greater than one-half of the buffer depth, the EB 234 is considered to be more than half full and thus approaching an overflow. One of ordinary skill in the art will recognize based on this description that a similar timing diagram may be drawn for an underflow condition.

Regarding the pointer comparison logic 316 (FIG. 3), an algorithm for determining the position of the pointers may be as follows. If the adjusted unload pointer is greater than the synchronized load pointer, than the difference between the adjusted unload pointer and the synchronized load pointer is the number of entries that are free within the queue. On the other hand, if the synchronized load pointer is greater than the adjusted unload pointer, than the difference between the synchronized load pointer and the adjusted load pointer is the number of entries that are taken within the queue. Of course, when the synchronized load pointer is equal to the adjusted unload pointer, the pointers have collided, that is the EB 234 has either overflowed or underflowed. Pointer collision may be due to for instance a lack of received non-data sequences, or that the difference between the grxclk and lgclk frequencies is too high and outside of a design specification. In that case, an indication will be sent, to a subsequent symbol processing block or to an upper layer of Device A, that the pointers have collided, thereby initiating a recovery state in which the pointers in all lanes of a given link (see FIG. 2) are moved back to their initial or reset values.

Turning now to FIGS. 6 and 7, example timing diagrams that illustrate how the non-data sequence may be processed to avoid overflow and underflow conditions are shown. Recall that as mentioned above, when a SKP Ordered-Set has been received, a flag is generated at the inlet of the buffer 304 and passed along with a symbol of the Ordered-Set through the buffer. In the examples described here, the adjustment that is applied to manage the buffer takes place at the outlet of the buffer, that is in the lgclk domain. In particular, it is the unload pointer that is adjusted, depending on the state of the buffer (e.g., half full, more than half full, or less than half full). FIG. 6 illustrates the timing diagram for a process of adjusting or controlling the unload pointer, in the event that the buffer is more than half full. Note how in this example, grxclk is faster than lgclk thereby likely to cause an overflow condition. An SKP Ordered-Set, which includes a COM followed by a single SKP in this case, is received at the inlet of the EB 234. The buffer is then loaded with the SKP detect flag (EbSkpDetin) in cycle 1, aligned with the COM, into entry 9 of the buffer.

Note that in the lgclk domain, the pointers are five entries apart (so that neither EbMrHlfFull or EbLsHlfFull is asserted), until cycle 3. At that point, the synchronized load pointer has moved from entry 8 to entry 0, indicating that the load pointer has moved one cycle more than the unload pointer. In cycle 7, the SKP detect flag (EbSkpDetOut) associated with the SKP Ordered-Set is unloaded from the buffer (entry 9). With the buffer now being more than half full, the unload pointer EbUldPtr will move an extra entry forward, that is instead of moving to entry 0, the pointer will move to entry 1. With the adjusted unload pointer, EbUldPtrAdj, reflecting the movement of the unload pointer, the difference between EbUldPtrAdj and EbLdPtrSync is back to five entries, and the buffer status is updated in cycle 9 with the deassertion of the more than half full indicator. Thus, changing the unload pointer by more than one entry results in a non-data symbol, in this case SKP, that was loaded in the buffer to be skipped while the symbols are being unloaded as reflected in EbDataOut[7:0].

Turning now to FIG. 7A, an example timing diagram of a process for managing the EB 234 when the buffer is less than half full, to avoid underflow, is shown. In this case, the grxclk domain is slower than the lgclk domain, so that the buffer is draining faster than it is being filled. At the top of the diagram, there is a non-data sequence that has been inserted into the data sequence that arrive at the inlet of the EB 234, as indicated by EbDataIn.

The COM symbol along with the SKP detect flag will be stored in entry 9, as shown under cycle 1 of grxclk. Next, referring now to the lgclk domain, the buffer is half full up until cycle 3 where the synchronized load pointer stays at entry 9 for two cycles while the adjusted unload pointer continues to increment. This is due to the mismatch or tolerance difference between grxclk and lgclk, as exemplified above in the timing diagram of FIG. 5. Accordingly, in cycle 4, the less than half full indicator is asserted. In cycle 6, the SKP detect flag is unloaded from the buffer with EbLsHlfFull being asserted, and the unload pointer EbUldPtr is stalled in cycle 7 with the assertion of HldUldPtr. This causes the unload pointer to remain on entry 0 in cycle 7 (where that entry contains SKP). Thus, a further SKP is inserted into the sequence, as can be seen in cycle 7 of EbDataOut[7:0].

Next, when the synchronize load pointer and the adjusted unload pointer are compared at the transition from cycle 7 to cycle 8, the pointers are again back to five entries apart such that the pointers of the EB 234 have returned to their ideal condition.

The following provides another description of how the load and unload pointers are operated in the examples above. For the load pointer, this pointer may increment by one at all times (according to grxclk) so long as the EB 234 is active or enabled. However, as to the unload pointer, the unload pointer (after being initialized) increments by one (according to lgclk) only if the EB 234 is not currently processing a non-data sequence when the buffer is more than half full, and the non-data sequence has not been received in the last cycle with the buffer being less than half full. In addition, the unload pointer may increment by two when processing the non-data sequence and the buffer is more than half full. Finally, the unload pointer is not incremented, that is stalled, when a non-data sequence has been received in the last cycle and the buffer is less than half full.

An advantage of the above-described method and apparatus for managing an elastic buffer is that it is a relatively robust technique that maintains a steady flow of symbols received for a serial point to point link despite the tolerance allowed in the transmit and receive clocks. Note that the process may be performed not only during initial training, prior to bringing a link into operation after power up, but also during reception of every packet by the IC device (where it is assumed that each packet will include one or more instances of the special, non-data sequence every so often so as to allow the process to be repeated during normal operation of a given lane). In another embodiment of the invention, the Device A (see FIG. 1) can operate in far end loop back mode (FELB). In FELB, a sequence of symbols received in Device A is looped back out to Device B after the sequence has been buffered (by the EB 234, see FIG. 2). Accordingly, in FELB, the symbol content of a buffered sequence may be monitored outside the Device A, to determine how the original sequence (as transmitted by Device B) was modified by the EB 234 of Device A.

Start-Up of the Elastic Buffer Pointers

Another embodiment of the invention lies in a start-up mechanism that automatically adjusts to the asynchronous, clock crossing delays that are encountered in the EB 234, and helps reduce the required size of the buffer 304. In such an embodiment, the start-up of the load and unload pointers of the EB 234 may be based on two different criteria. An qual_EbActive term may be defined that is generated in the lgclk domain (unload pointer domain) which is then clock crossed over to the grxclk domain (load pointer domain). This term when asserted releases the load pointer. The qual EbActive term may consist of the following conditions: 1) A Link Initialization unit (not shown) of the link interface 124 indicates that the lane for this EB 234 is up (e.g. gi_gp_laneup is asserted—lgclk domain); 2) The receive clock of the interface 124 is enabled (gi_gp_piclken is asserted—lgclk domain); 3) The EB 234 pointers are not being reset (gi_gp_ebptrrst not asserted due to pointer collision—lgclk domain); 4) The symbol alignment logic 228 (see FIG. 2) has attained symbol lock (gp_gi_kalignlck—lgclk domain); and 5) The load pointer has been reset. This term may be added for the embodiment where there is a PCI Express L0s entry/exit condition (sync_loadreset_done—lgclk domain).

Once the load pointer has been released, it is clock crossed to the lgclk domain. In this clock domain the fact that a load pointer has changed in successive clocks is an indication that the unload pointer can now be released. The unload pointer will continue incrementing until any of the above five conditions become false in which case the unload pointer may be reset and after some time the load pointer also will reset (clock crossing).

As an example, the unload pointer may be reset to a value of “000”. In contrast, the load pointer may be initialized to a value of “001”. The reason for this is to begin with a buffer half-full scenario, but account for, in this example, two clocks of clock crossing penalty (for the load pointer to clock cross and kick off the unload pointer) and also account for a flop stage that actually generates the Ebactive_unload term. This means the load pointer may start off at a value of “001”. Note that the unload pointer may still be decremented, by two, for making comparisons to check the buffer space. This technique may always start with the same, EbMrHlfFull condition. However, this is not of concern as the first instance of the non-data symbol SKP that arrives at the EB 234 will make the buffer 304 (here, a queue) HalfFull again.

In the example timing diagram of FIG. 7B, the active indicator in the core clock domain (qual_EbActive) is asserted in cycle 1 of the core clock domain (lgclk). The active indicator is then sent to the grxclk domain to create the sync_EbActive_load signal, which is then asserted in cycle 3. With the assertion of the sync_EbActive_load signal, the load pointer (ldptr) is released from its reset value and will begin to move. Meanwhile, the unload pointer (unldptr) in the core clock domain lgclk is prevented from moving until the sync_ldptr has started moving. By cycle 6, the synchronized load pointer has started moving, before the unload pointer and the adjusted unload pointer have started moving. This results in the assertion of the more than half full signal (EbMrHlfFull ). Note that the start up mechanism in this example always results in the MrHlfFull being asserted initially, but then the first instance of SKP that arrives will bring the queue to the HlfFull condition. Accordingly, the startup condition of MrHlfFull may be referred to as a transient condition.

It should also be noted that when the unload pointer of the EB 234 has begun operating after being held in it's reset state, the data at the outlet of the queue may not be valid until the unload pointer reaches the entry of the queue to which the load pointer was reset (i.e. the first entry of the queue). To prevent non-valid data from corrupting subsequent symbol processing stages (e.g., deskew circuitry 238, FIG. 2), the SKP detect flag and the K-character (non-data symbol present) bit from the outlet of the queue may be gated with a valid indicator or flag, referred to as EbOutVld. As depicted in the example timing diagram of FIG. 7C, this indicator may remain de-asserted while the unload pointer is prevented from moving (and the EB 234 is deemed inactive), and will not be asserted until the unload pointer moves to the reset value of the load pointer (which happens to be ENT0 in FIG. 7C). The rules below may be used to define the operation of this EbOutVld flag: 1) EbOutVld is asserted when the EB 234 is active (qual_EbActive is asserted) and the unload pointer has moved to the load pointer's reset state; and 2) EbOutVld is deasserted when the EB 234 is de-activated (qual_EbActive is de-asserted). As mentioned above, the valid flag at the outlet of the EB 234 may prevent both the SKP detect flag, EbSkpDetOut, and the K-character detect flag, EbKcharDetOut, from being asserted erroneously from non-valid symbols stored in the queue.

### OTHER SYSTEM EMBODIMENTS

The above-described link interface circuitry and methodology may also be implemented in IC devices that are designed to communicate via a serial, point to point interconnect technology that provides isochronous support for multimedia. Isochronous support is a specific type of QoS (Quality of Service) guarantee that data is delivered using a deterministic and time-dependent method. Platform-based isochronous support relies on a documented system design methodology that allows an application that requires a constant or dedicated level of access to system resources to gain the required bandwidth at a given time interval.

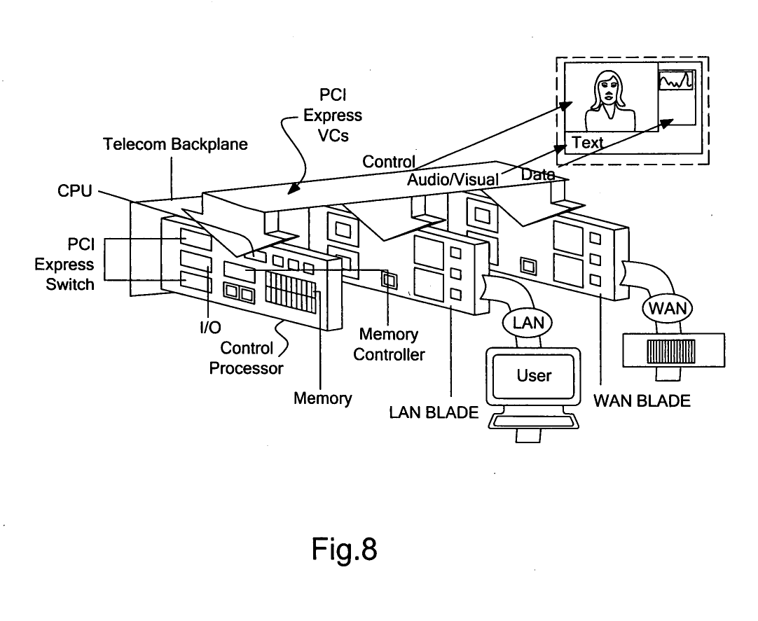

An example is that of watching an employee broadcast that originates from the company's CEO, on a desktop while working on a report, as shown in FIG. 8. Data is routed from the intranet into the desktop main memory where the application utilizes the data to create an audio stream sent to the user's headphones via an add-in card and a video stream sent to the display via a graphics controller. If simultaneous operations are occurring within the desktop personal computer (PC), such as disk reads, data coming off the Internet, word processing, email, and so on, there is no guarantee that the audio and video stream will be truly glitchless. Data is delivered on a “best effort” method only. The user may experience skips or stalls as applications compete for the same resources. Isochrony in PCI Express solves this problem by establishing a mechanism to guarantee that time-sensitive applications are able to secure adequate system resources. For example, in FIG. 8, the video time-sensitive data would be guaranteed adequate bandwidth to prevent skips at the expense of non-critical data such as email.

The above-described link interface circuitry and methodology may also be implemented in IC devices that are designed to communicate via a serial point to point link technology that is used in communications equipment, from embedded applications to chassis-based switching systems. In advanced switching, mechanisms are provided to send packets peer-to-peer through the switch fabric. These markets also benefit from the server class hardware-based error detection that is available with PCI Express. There may be two main types of usages within communications equipment, control plane processing and data plane processing. Control plane refers to the control and configuration of the system. The serial link may be used as the interface to configure and control processors and cards within a large number of systems. Chassis-based building switches typically have various cards that can be inserted and used. Chassis-based switches may offer field-upgradeability. Most switching systems offer the ability to only populate half of the chassis initially and add cards with additional ports or faster speed connections as demand or the number of users increase. The serial link technology could be used as a control plane interconnect to configure and monitor the different types of cards installed within the system. The enumeration and established configuration protocol within PCI Express, for example, lends itself to a low pin count, high bandwidth interface to configure cards and services.

The data plane refers to the actual path that the data flows. In the data plane, an advanced switching extension may define mechanisms to encapsulate and send PCI Express data packets across peer-to-peer links through the switch fabric.

The PCI Express core architecture may provide a solid foundation for meeting new interconnect needs. The Advanced Switching (AS) architecture overlays on this core and establishes an efficient, scalable, and extensible switch fabric through the use of a specific AS header inserted in front of the PCI Express data packet at the Transaction Layer. AS switches only examine the contents of the header that provide routing information (where to send the packet), traffic class ID (quality of service information), congestion avoidance (for preventing traffic jams), packet size, and protocol encapsulation. By separating the routing information, switch designs are simpler and cost-effective. Additionally, adding an external header to the packet enables the switch fabric to encapsulate any number of existing protocols.

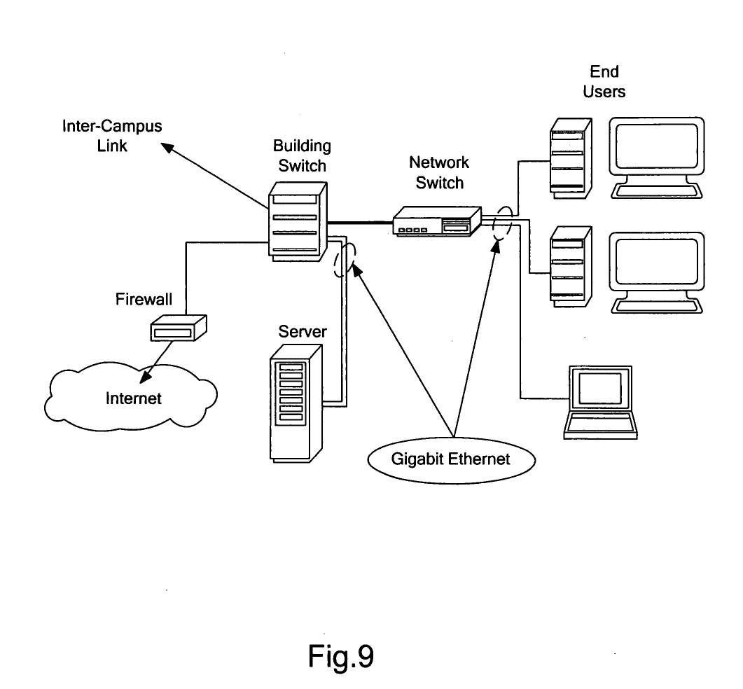

The above-described link interface circuitry and methodology may also be implemented in IC devices that are designed to communicate via a serial point to point interconnect technology that is used for network connections (in place of Gigabit Ethernet, for example). The network connection may be for corporate mobile and desktop computers for sharing files, sending emails, and browsing the Internet. Servers as well as communications equipment may be expected to implement such network connections. An example of such a network connection within the enterprise network is shown in FIG. 9.

Although the above examples may describe embodiments of the invention in the context of combinational and sequential logic circuits, other embodiments of the invention can be implemented by way of software. For example, some embodiments, may be provided as a computer program product or software which may include a machine or computer-readable medium having stored thereon instructions which may be used to program a computer (or other electronic devices) to perform a process according to an embodiment of the invention. In other embodiments, operations might be performed by specific hardware components that contain microcode, hardwired logic, or by any combination of programmed computer components and custom hardware components.

Further, a design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, data representing a hardware model may be the data specifying the presence or absence of various features on different mask layers for masks used to produce the integrated circuit. In any representation of the design, the data may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or retransmission of the electrical signal is performed, a new copy is made. Thus, a communication provider or a network provider may make copies of an article (a carrier wave) that features an embodiment of the invention.

To summarize, various embodiments of a method and apparatus for managing an elastic buffer of a serial point to point link have been described. In the foregoing specification, the invention has been described with reference to specific exemplary embodiments thereof. It will, however, be evident that various modifications and changes may be made thereto without departing from the broader spirit and scope of the invention as set forth in the appended claims. For example, although the system embodiment has been described using the serial point to point link as a chip to chip connection between two devices on a printed wiring board such as in a desktop, server, or notebook computer, the buffer management technique may also be used with serial point to point links that are part of an external bus for connecting the computer to a peripheral such as a keyboard, monitor, external mass storage device, or camera. The point to point link may be used in not only computer systems, but also dedicated communications products such as mobile phone units, telecommunication switches, and data network routers. The specification and drawings are, accordingly, to be regarded in an illustrative rather than a restrictive sense.

1. A method comprising:
a) receiving a plurality of symbols in a first integrated circuit (IC) device, the symbols having been transmitted by a second IC device and received over a serial point to point link, wherein the plurality of symbols include a non-data sequence inserted according to a predetermined methodology into a data sequence by the second IC device;
b) loading the plurality of symbols into a buffer according to a load pointer;
c) unloading the data sequence and some of the non-data sequence from the buffer according to a changing unload pointer that points to different entries of the buffer, wherein the unload pointer is changed by one entry each time a symbol is unloaded; and
d) to prevent overflow of the buffer, and in response to (i) detecting the non-data sequence at an inlet of the buffer and (ii) passing an indicator that refers to such detection through the buffer, changing the unload pointer by more than one entry so that a non-data symbol of the non-data sequence, as loaded in the buffer, is skipped while unloading in c).

2. The method of claim 1 wherein the non-data sequence is detected by detecting a combination of a first non-data symbol followed by a second, different non-data symbol in said non-data sequence.

3. The method of claim 2 wherein the passing of the indicator comprises generating a flag in response to detecting the first and second non-data symbols of said non-data sequence, and aligning the flag with the first non-data symbol when loading the flag with said non-data sequence into the buffer in b).

4. The method of claim 3 wherein the unload pointer is changed in d) in response to detecting the flag at an outlet of the buffer, so that the second non-data symbol, as loaded in the buffer, is skipped.

5. The method of claim 1 wherein the non-data sequence is a PCI Express sequence that includes the non-data symbol COM followed by the non-data symbol SKP.

6. A method comprising:
a) receiving a plurality of symbols in a first integrated circuit (IC) device, the symbols having been transmitted by a second IC device and received over a serial point to point link that couples the first and second IC devices, wherein the plurality of symbols include a non-data sequence inserted into a data sequence by the second IC device;
b) loading the plurality of symbols into a buffer according to a load pointer;
c) unloading the data sequence and some of the non-data sequence from the buffer according to a changing unload pointer, wherein the unload pointer is changed by one entry of the buffer each time a symbol is unloaded; and
d) to prevent underflow of the buffer, and in response to (i) detecting the non-data sequence at an inlet of the buffer and (ii) passing an indicator that refers to such detection through the buffer, stalling the unload pointer at an entry of the buffer that contains a non-data symbol while unloading in c).

7. The method of claim 6 wherein the non-data sequence is detected by detecting a combination of a first non-data symbol followed by a second, different non-data symbol in said non-data sequence.

8. The method of claim 7 wherein the passing of the indicator comprises:
generating a flag in response to detecting the first and second non-data symbols of said non-data sequence, and aligning the flag with the first non-data symbol when loading said non-data sequence into the buffer in b).

9. The method of claim 8 wherein the unload pointer is stalled, in response to detecting the flag at an outlet of the buffer, at an entry of the buffer that contains the second non-data symbol of the non-data sequence.

10. The method of claim 6 wherein the non-data sequence is a PCI Express sequence that includes the non-data symbol COM followed by the non-data symbol SKP.

11. An integrated circuit (IC) device comprising:
a buffer having an input to receive a plurality of symbols that were transmitted by another IC device over a serial point to point link, the buffer having a plurality of entries;
detect logic having an input to receive the plurality of symbols and an output to feed the input of the buffer a non-data symbol sequence identifier;
first pointer logic to provide a first pointer to sequentially load the plurality of symbols into the plurality of entries of the buffer, respectively;
second pointer logic to provide a second pointer to sequentially unload the plurality of symbols from the plurality of entries of the buffer, respectively;
comparison logic to compare the first and second pointers; and
pointer control logic having an output coupled to the second pointer logic,
wherein the pointer control logic is to stall the second pointer at an entry that contains a non-data symbol, in response to a) said identifier appearing at the output of the buffer, and b) the comparison logic indicating that the buffer is less full than a predetermined threshold.

12. The IC device of claim 11 wherein the plurality of symbols are to be received in accordance with a first clock signal which is to be derived from a transmit clock of said another IC device.

13. The IC device of claim 12 wherein the first clock signal is to be derived from the transmit clock being embedded in a stream of information that contains the plurality of symbols and is to be transmitted by said another IC device.

14. The IC device of claim 12 wherein the second pointer logic is to advance the second pointer in accordance with a second clock signal that is derived from a local clock of the IC device,
and wherein the first pointer logic is to advance the first pointer in accordance with the first clock signal.

15. A system comprising:
a processor;
a main memory; and
an integrated circuit (IC) device which is communicatively coupled to the processor and the main memory and provides the processor with I/O access, the IC device having link interface circuitry that supports a serial, point to point link, the circuitry includes
a buffer having an input to receive a plurality of symbols that were transmitted over the link, the buffer having a plurality of entries,
detect logic having an input to receive the plurality of symbols and an output to feed the input of the buffer a non-data symbol sequence identifier,
first pointer logic to provide a first pointer to load the plurality of symbols into the plurality of entries of the buffer, respectively,
second pointer logic to provide a second pointer to sequentially unload the plurality of symbols from the plurality of entries of the buffer,
comparison logic to compare the first and second pointers, and
pointer control logic having an output coupled to the second pointer logic, wherein the pointer control logic is to stall the second pointer at an entry that contains a non-data symbol, in response to a) said identifier appearing at the output of the buffer, and b) the comparison logic indicating that the buffer is less full than a predetermined threshold.

16. The system of claim 15 wherein the plurality of symbols are to be received in accordance with a first clock signal which is to be derived by the IC device from a transmit clock of another device.

17. The system of claim 16 wherein the first clock signal is to be derived from the transmit clock being embedded in a stream of information that contains the plurality of symbols and is to be transmitted by said another device.

18. The system of claim 16 wherein the second pointer logic is to advance the second pointer in accordance with a second clock signal that is derived from a local clock of the root complex,
and wherein the first pointer logic is to advance the first pointer in accordance with the first clock signal.

19. The system of claim 15 further comprising a graphics element; and
wherein the IC device is a memory controller hub (MCH) that communicatively couples the processor to the main memory and the graphics element.

20. The system of claim 15 wherein the IC device is an I/O controller hub (ICH) that communicatively couples the processor to peripheral devices.

21. A method for buffer management, comprising:
detecting a predefined non-data symbol sequence at an inlet of an elastic buffer;
passing an identifier that represents detection of said sequence through the elastic buffer; and
processing the identifier at an outlet of the elastic buffer to avoid one of overflow and underflow conditions in the elastic buffer.

22. The method of claim 21 wherein the sequence is a PCI Express SKP Ordered Set.

23. The method of claim 21 wherein the processing is designed to maintain the elastic buffer in a half-full state.

24. An integrated circuit (IC) device comprising:
a buffer having an input to receive a plurality of symbols that were transmitted by another IC device over a serial point to point link, the buffer having a plurality of entries;
detect logic having an input to receive the plurality of symbols and an output to feed the input of the buffer a non-data symbol sequence identifier;
first pointer logic to provide a first pointer to sequentially load the plurality of symbols into the plurality of entries of the buffer, respectively;
second pointer logic to provide a second pointer to sequentially unload the plurality of symbols from the plurality of entries of the buffer, respectively;
comparison logic to compare the first and second pointers; and
pointer control logic having an output coupled to the second pointer logic, wherein the pointer control logic is to advance the second pointer by more than one entry to skip over an entry that contains a non-data symbol, in response to a) said identifier appearing at the output of the buffer, and b) the comparison logic indicating that the buffer is more full than a predetermined threshold.

25. The IC device of claim 24 wherein the plurality of symbols are to be received in accordance with a first clock signal which is to be derived from a transmit clock of said another IC device.

26. The IC device of claim 25 wherein the first clock signal is to be derived from the transmit clock being embedded in a stream of information that contains the plurality of symbols and is to be transmitted by said another IC device.

27. The IC device of claim 25 wherein the second pointer logic is to advance the second pointer in accordance with a second clock signal that is derived from a local clock of the IC device, and wherein the first pointer logic is to advance the first pointer in accordance with the first clock signal.

28. A system comprising:
a processor;
a main memory; and
an integrated circuit (IC) device which is communicatively coupled to the processor and the main memory and provides the processor with I/O access, the IC device having link interface circuitry that supports a serial, point to point link, the circuitry includes
a buffer having an input to receive a plurality of symbols that were transmitted over the link, the buffer having a plurality of entries,
detect logic having an input to receive the plurality of symbols and an output to feed the input of the buffer a non-data symbol sequence identifier,
first pointer logic to provide a first pointer to load the plurality of symbols into the plurality of entries of the buffer, respectively,
second pointer logic to provide a second pointer to sequentially unload the plurality of symbols from the plurality of entries of the buffer,
comparison logic to compare the first and second pointers, and
pointer control logic having an output coupled to the second pointer logic, wherein the pointer control logic is to advance the second pointer by more than one entry to skip over an entry that contains a non-data symbol, in response to a) said identifier appearing at the output of the buffer, and b) the comparison logic indicating that the buffer is more full than a predetermined threshold.

29. The system of claim 28 wherein the plurality of symbols are to be received in accordance with a first clock signal which is to be derived by the IC device from a transmit clock of another device.

30. The system of claim 29 wherein the first clock signal is to be derived from the transmit clock being embedded in a stream of information that contains the plurality of symbols and is to be transmitted by said another device.

31. The system of claim 29 wherein the second pointer logic is to advance the second pointer in accordance with a second clock signal that is derived from a local clock of the root complex,
and wherein the first pointer logic is to advance the first pointer in accordance with the first clock signal.

32. The system of claim 28 further comprising a graphics element; and
wherein the IC device is a memory controller hub (MCH) that communicatively couples the processor to the main memory and the graphics element.

33. The system of claim 28 wherein the IC device is an I/O controller hub (ICH) that communicatively couples the processor to peripheral devices.
